(19) United States
(12) Patent Application Publication
(10) Pub. No.: US 2008/0304492 A1
(43) Pub. Date: Dec. 11, 2008

(54) VCAT TRANSMISSION SYSTEM AND VCAT BAND CONTROL METHOD

(76) Inventors: MASAKI KURIYAMA, Tokyo (JP); Junichiro Matsui, Tokyo (JP)

Correspondence Address: NEC CORPORATION OF AMERICA, 6535 N. STATE HWY 161, IRVING, TX, 75039, US

(21) Appl. No.: 12/135,598

(22) Filed: Jun. 9, 2008

(30) Foreign Application Priority Data
Jun. 11, 2007 (JP) 2007-153698

(51) Int. Cl. H04L 12/56

(52) U.S. Cl. 370/397

(57) ABSTRACT

A source node or a sink node retains path information of a VC path and actualizes an efficient process in an LCAS process on the basis of the path information. This can actualize an efficient process procedure in the LCAS and reduce an amount of loss data.

This application is based upon and claims the benefit of priority from Japanese patent application No. 2007-153698, filed on Jun. 11, 2007, the disclosure of which is incorporated herein in its entirety by reference.

### BACKGROUND OF THE INVENTION

1. Field of the Invention

The present invention relates to a virtual concatenation (VCAT) (ITU-T G.707) and a link capacity adjustment scheme (LCAS) (ITU-T G.7042) in a digital transmission system.

2. Description of Related Art

VCAT is technology which is adopted for using bands in a synchronous digital hierarchy (SDH) or synchronous optical network (SONET) digital transmission network.

An LCAS actualizes addition or deletion of a band without instantaneous interruption by commands and also actualizes autonomous deletion or recovery of a virtual container (VC) path/member at fault time. This function is actualized by independent bidirectional communication of a VC path/member unit by a communication node on the transmission side referred to as a So (source node (SoNode)) and a communication node on the receiving side referred to as an Sk (sink node (SkNode)). The operation of addition or deletion of the bands is independent for each unilateral direction.

FIG. 1 is an example of the SDH/SONET digital transmission network where there exist path differences. There exist three paths of route #1, route #2, and route #3 from the So to the Sk. Two transmission paths of the route #2 and the route #3 run in parallel in a zone from the So to a relay node a.

The So and the relay node a are connected by a Link #1, the relay node a and a relay node b are connected by a Link #2, the relay node b and the Sk are connected by a Link #3, the Sk and the relay node a are connected by a Link #4, the Sk and a relay node c are connected by a Link #5, and the relay node c and the So are connected by a Link #6.

The Link #1 is shared by the routes #2 and #3 between the So and the relay node a.

FIG. 2 shows a formation process of the VC path/member in the So. Signals to be inputted are accommodated in a path signal of a VC unit in a VCAT unit 30. In an LCAS unit 40, a periodical multi-frame pattern including information related to LCAS control such as CTRL (ConTRoL) (DNU (DoNotUse), NORM (Normal), EOS (EndOfSequence), etc. are transmitted) toward the Sk is added to a specified path overhead (POH) (H4 byte etc.) of the VC path.

Designation of connection between each VC path/member and each route is performed by using a control terminal (not shown in the drawing) associated with the So. By this setting, each VC path/member reaches the Sk via each designated route.

FIG. 3 shows a termination process of the VC path/member in the Sk. In an LCAS unit 41 of the Sk, information about the LCAS control toward the Sk from a received multi-frame pattern is taken out. Then, in a VCAT unit 31, an input signal is recovered from the path signal of a VC unit and outputted.

In response to the information taken out in the LCAS unit 41, a periodical multi-frame pattern including information related to the LCAS control such as MST (MemberSTatus) (FAIL, OK, etc. are transmitted when CTRL is received) and the like toward the So in a reverse direction is added to the specified path overhead of the VC path.

Designation of connection between each VC path/member and each route is made by using a control terminal (not shown in the drawing) associated with the Sk. By this setting, each VC path/member reaches the Sk via each designated route.

Next, a problem of the above-mentioned related art will be described.

In such VCAT, at the application of an LCAS control procedure which processes for each VC path/member, its process delay or transmission delay and data loss associated therewith become problem.

A related problem will be described with reference to FIG. 4. FIG. 4 shows an LCAS process sequence which leads to autonomous deletion of the VC path/member at the time when a fault occurs in the zone Link #1 in which two routes (route #2 and route #3) where there exists a path difference of the conventional configuration (a main signal process of the So is the configuration shown in FIG. 2, and a main signal process of the Sk is the configuration shown in FIG. 3) run in parallel between the So and the relay node a. Reference letters d1, d2, and d3 shown in the drawing denote the distance of the route #1, route #2, and route #3, respectively. Furthermore, a difference of a round-trip propagation time (propagation delay) between the route #1 and the route #2 is set to t2; and a difference of a round-trip propagation time (propagation delay) between the route #1 and the route #3 is set to t3.

When a fault at the route #2 or #3 is detected at the Sk, FAIL is issued toward the So via the route #1. The So issues DNU toward the Sk after receiving the FAIL. In addition, the Sk starts deletion of the VC path/member when the FAIL is issued. The So starts deletion of the relevant VC path/member after issuing the DNU.

Formerly, the LCAS control procedure which is independent for each VC path/member is implemented, and it comes under the influence of a process delay (t1 shown in the drawing) in the So or Sk and a round-trip propagation delay in each route (t2 and t3 shown in the drawing) when the LCAS is operated; and therefore, a time t4 is required till an autonomous deletion procedure of the VC path/member is completed after detecting the fault.

That is, even a fault occurs in the Link #1, it is required to transmit and receive the FAIL and the DNU for each of a plurality of routes with which the Link #1 is shared; and therefore, there is a room for improvement in an increase of efficiency in process procedure.

### SUMMARY OF THE INVENTION

The present invention has been made under such background, and it is an exemplary object to provide a VCAT transmission system and a VCAT band control method, both of which can actualize efficient process procedure in an LCAS and reduce an amount of loss data.

### [VCAT Transmission System]

To attain the aforementioned object, a VCAT transmission system as a first aspect of the present invention includes: a source node that accommodates an input signal in a path signal of a VC unit and transmits by using a VC path; and a sink node that receives the path signal of the VC unit, transmitted by the VC path and outputs a received signal. The present invention is characterized in that the source node or the sink node includes means for retaining path information of the VC path.

### [VCAT Band Control Method]

Furthermore, a VCAT band control method as a second aspect of the present invention is characterized to retain and use information of a node adjacent to the self source node or information of a relay node on a path from the self source node to the sink node as path information.

### [Program]

Further, a program as a third aspect of the present invention allows a general purpose information processing apparatus to actualize a function commensurate with a function of a source node or a sink node of the present invention by installing in the general purpose information processing apparatus.

### BRIEF DESCRIPTION OF THE DRAWINGS

FIG. 1 is a diagram showing an example of a digital transmission network;

FIG. 2 is a configuration diagram showing a main signal process of a relevant So;

FIG. 3 is a configuration diagram showing a main signal process of a relevant Sk;

FIG. 4 is a diagram showing a relevant process sequence;

FIG. 5 is a configuration diagram of a main signal process of an So of the present embodiment (adjacent node information retention of the So);

FIG. 6 is a configuration diagram of a main signal process of an Sk of the present embodiment (adjacent node information retention of an So);

FIG. 7 is a diagram showing a connection setting example for each VC path/member;

FIG. 8 is a diagram showing an example of a management table of a path information retention unit in which the adjacent node information of the So is recorded;

FIG. 9 is a configuration diagram of a main signal process of an So of the present embodiment (network information retention);

FIG. 10 is a configuration diagram of a main signal process of an Sk of the present embodiment (network information retention);

FIG. 11 is a view showing an example of a management table of a path information retention unit in which the network information is recorded;

FIG. 12 is a diagram showing a process sequence of the present embodiment (path information retention unit on Sk side);

FIG. 13 is a diagram showing a process sequence of the present embodiment (path information retention unit on So side); and

FIG. 14 is a configuration diagram of a main signal process of an Sk of the present embodiment (information acquisition from POH).

### EXEMPLARY EMBODIMENT

Hereinafter, embodiments of the present invention will be described with reference to drawings.

### Outline Explanation of Exemplary Embodiment

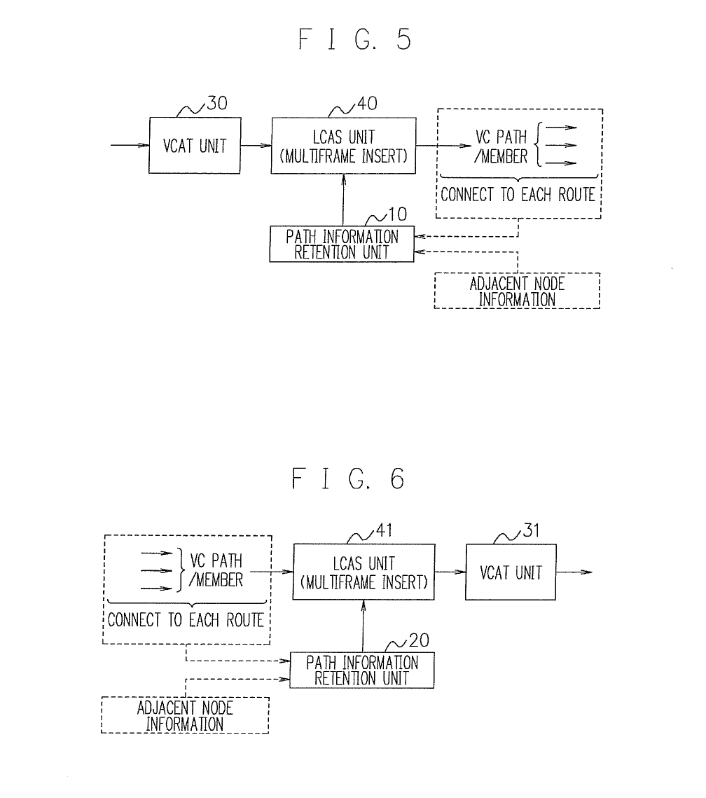

An exemplary embodiment of the present invention will be described with reference to drawings. FIG. 5 is a diagram showing a configuration of a main signal process of an So of the present embodiment. FIG. 6 is a diagram showing a configuration of a main signal process of an Sk of the present embodiment.

The present embodiment is a VCAT transmission system which includes the So in which an input signal is accommodated in a path signal of a VC unit and is transmitted by using a VC path as shown in FIG. 5, and the Sk in which the path signal of a VC unit transmitted by the VC path is received and a received signal is outputted as shown in FIG. 6. A system configuration will be described as a configuration shown in FIG. 1.

In this case, it is characterized in that the So or the Sk is provided with a path information retention unit 10 or 20 which retains path information of the VC path.

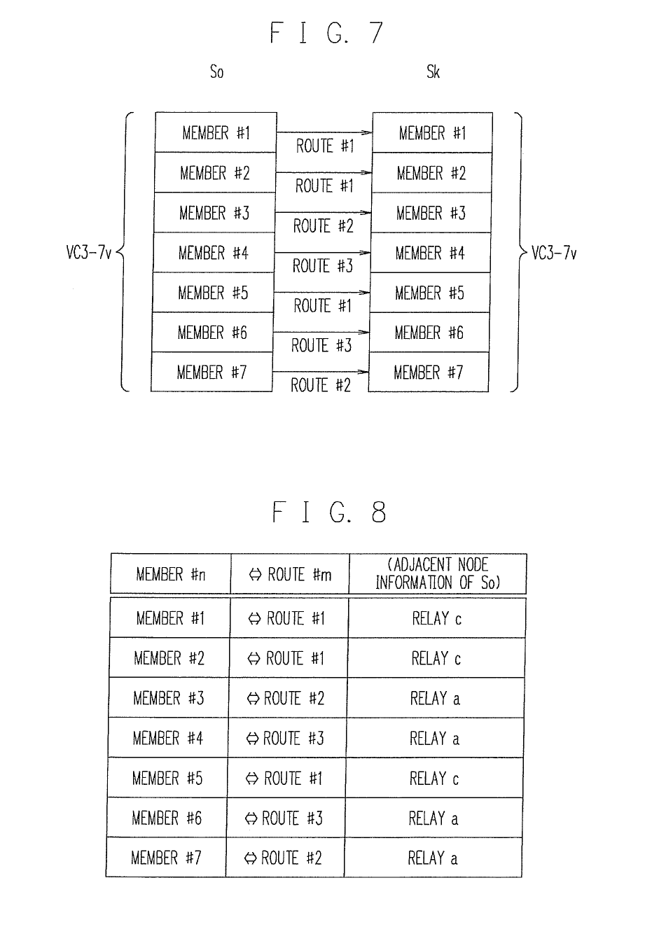

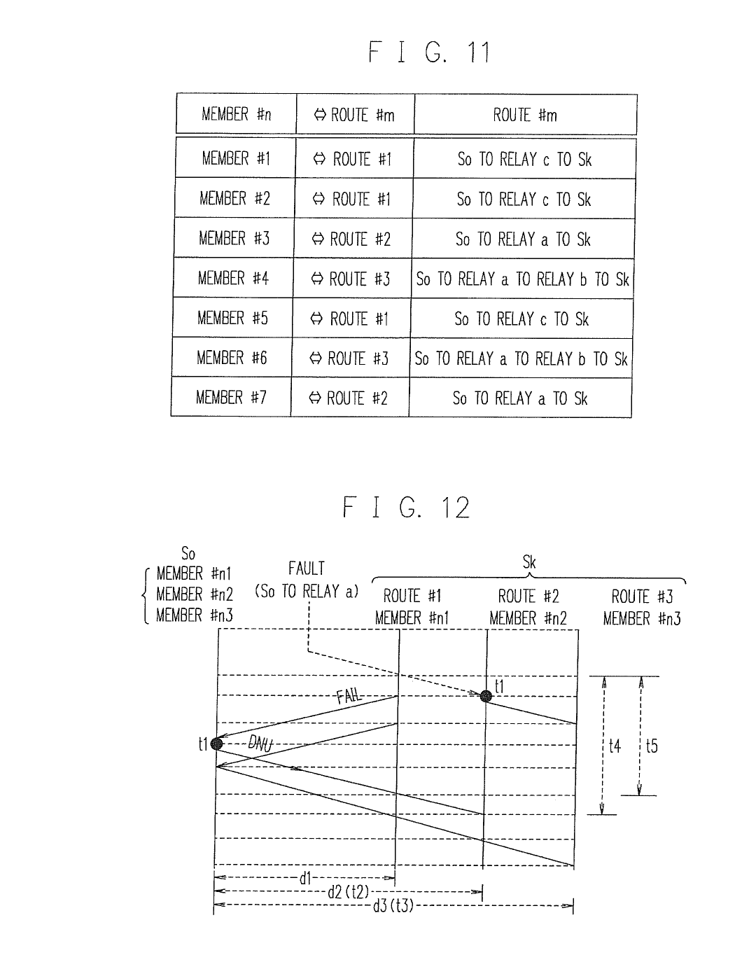

FIG. 7 is a diagram showing a connection setting example for each VC path/member; and FIGS. 8 and 11 are drawings showing configuration examples of management tables of the path information retention units 10 or 20. The path information is grouped in a path unit (hereinafter, referred to as “path group”) for each connection destination as shown in FIG. 7, and includes information of a relay node adjacent to the So as shown in FIG. 8. Alternatively, the path information includes information of relay nodes on paths from the So to the Sk as shown in FIG. 11.

Furthermore, when path information is transmitted from the path information retention unit 10 of the So to the path information retention unit 20 of the Sk, the path information can be transmitted by being mounted on an empty byte such as an F3 byte of a path overhead in VC.

### Exemplary Embodiment of Program

There will be described an exemplary embodiment of a program which allows a general purpose information processing apparatus to actualize a function commensurate with a function of the So or the Sk of the present embodiment by being installed in the general purpose information processing apparatus.

The program of the present embodiment is recorded in a recording medium; and accordingly, the general purpose information processing apparatus can install the program of the present embodiment by using the recording medium. Alternatively, the program of the present embodiment can also be directly installed in the general purpose information processing apparatus via a network from a server which retains the program of the present embodiment.

This can actualize the function commensurate with the function of the So or the Sk of the present embodiment by using the general purpose information processing apparatus.

In addition, the program of the present embodiment includes not only one capable of directly being implemented by the general purpose information processing apparatus, but also one capable of being implemented by install in a hard disk or the like. Furthermore, compressed one and encrypted one are also included.

### Detail Explanation of Exemplary Embodiment

Hereinafter, the present embodiment will be further described in detail.

The present invention is characterized in that VC path connection information by a control terminal is used; when a fault is detected in one path group, its fault information is transmitted to a VC path/member of other path groups; and a band control based on an LCAS control procedure is promptly performed (started).

The present invention is useful because there can be suppressed a necessary time for LCAS control associated with a propagation delay between the routes (paths) in a digital transmission system where there exist path differences.

### Configuration of Exemplary Embodiment

The present embodiment is provided with the path information retention unit 10 which has a function in which information relevant to adjacent nodes as connection information of the So is reflected to addition or deletion of a band (VC path/member) to be implemented in an LCAS unit 40, as shown in FIG. 5. Alternately, in the Sk side, the present embodiment is provided with the path information retention unit 20 which has a function in which information relevant to adjacent nodes as connection information of the So is reflected to addition or deletion of a band (VC path/member) to be implemented in an LCAS unit 41, as shown in FIG. 6.

In the present embodiment, setting is made so that the VC paths/members of VC3-7v are connected to respective routes in the So and the Sk, as shown in FIG. 7. In the case where the setting is made from control terminals (not shown in the drawing), path groups are generated by associating the VC paths/members with connection destinations (routes) in the path information retention unit 10 or 20 shown in FIG. 5 or FIG. 6. A management table as shown in FIG. 8 is made by adding adjacent node information of the So to the path groups.

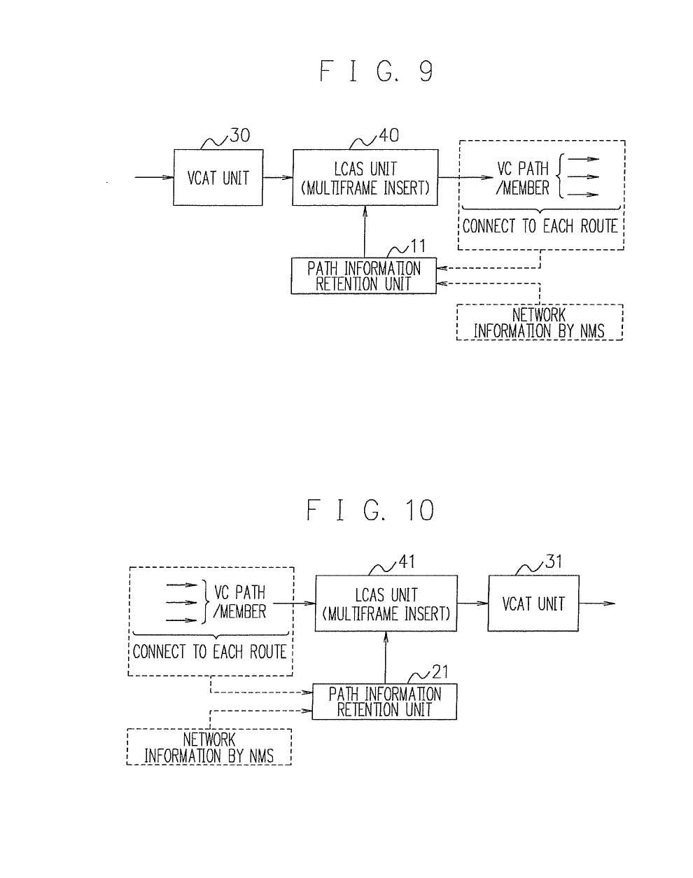

Alternatively, in the case where the setting is made from a network management system (NMS), network information relevant to the node in mid-flow of the route is added in addition to the connection information of the VC paths/members. In the path information retention unit 11 or 21 shown in FIG. 9 or FIG. 10, a management table which associates with halfway paths is made in addition to the members and connection destinations (routes) as shown in FIG. 11.

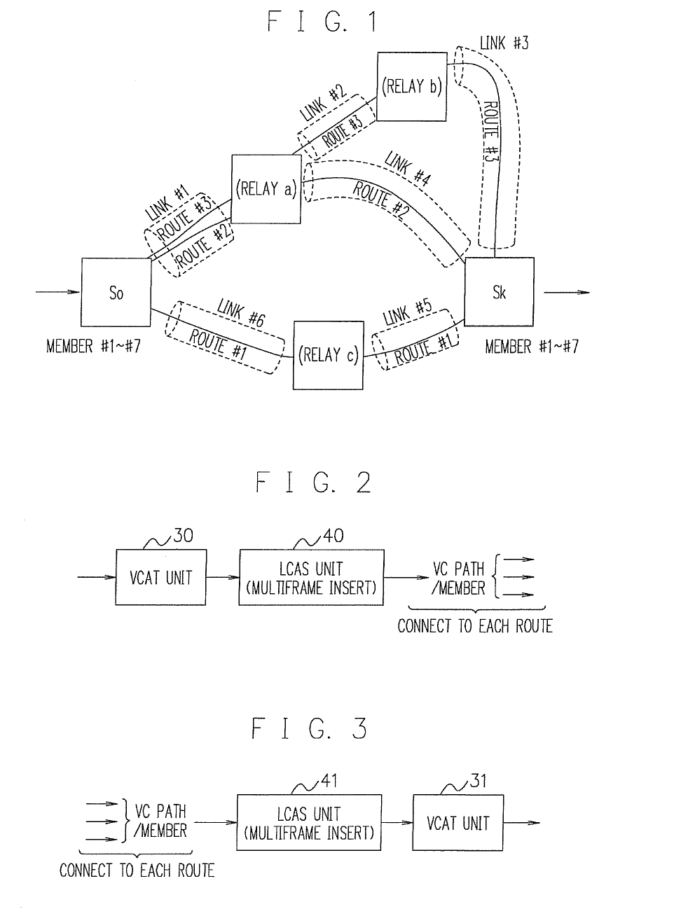

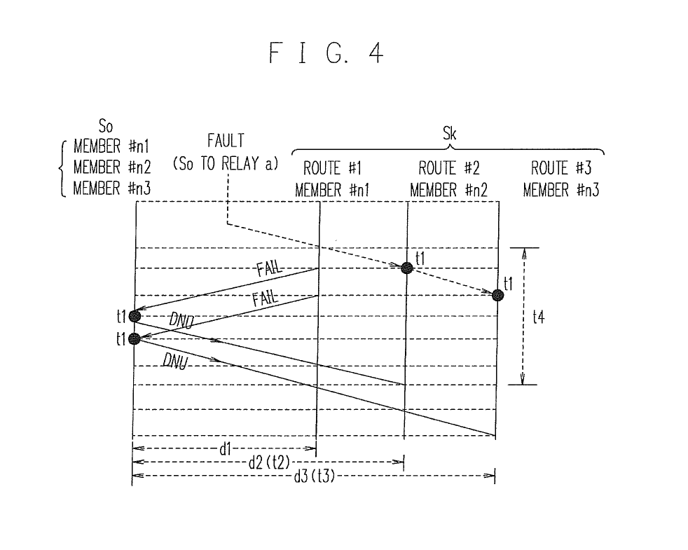

FIG. 4 shows the LCAS process sequence which leads to autonomous deletion of the VC path/member at the time when a fault occurs in the zone in which two routes (route #2 and route #3) where there exists a path difference of the conventional configuration (the main signal process of the So is the configuration shown in FIG. 2, and the main signal process of the Sk is the configuration shown in FIG. 3) run in parallel between the So and the relay node a.

When a fault is detected at the Sk, FAIL is issued toward the So via the route #1. The So issues DNU toward the Sk after receiving the FAIL. In addition, the Sk starts deletion of the VC path/member when the FAIL is issued. The So starts deletion of the relevant VC path/member after issuing the DNU.

Formerly, the LCAS control procedure which is independent for each VC path/member is implemented, and it comes under the influence of the process delay (t1 shown in the drawing) in the So or Sk and the round-trip propagation delay in each route (t2 and t3 shown in the drawing) when the LCAS is operated; and therefore, the time t4 is required till the autonomous deletion procedure of the VC path/member is completed after detecting the fault.

In the present embodiment, each of the VC paths/members independently generated in the VCAT unit can be considered as one path group for each connection destination (route) by using VC path connection information. Then, a time of a state where a part of the VC paths/members comprising the VCAT lead to data loss is interrupted can be suppressed by associating between the path groups of the VC paths/members using the path information or the connection information.

### First Exemplary Embodiment

A first exemplary embodiment will be described with reference to FIGS. 5, 6, and 12. FIG. 12 shows an LCAS process sequence which leads to autonomous deletion of a VC path/member at the time when a fault occurs in a zone (Link #1) in which two routes (route #2 and route #3), where there exists a path difference in the case where a main signal process of an So is the configuration shown in FIG. 2 and a main signal process of an Sk is the configuration shown in FIG. 6, run in parallel.

When a fault is detected in first by a VC path/member whose path is a short route (route #2), the Sk refers to a path information retention unit 20, recognizes its path group, and comprehends a relation between the So and an adjacent node; and in the case where a fault occurs in the route #2, it is recognized that the route #3 with which the Link #1 is shared is also out of order.

Consequently, the Sk issues FAIL toward the So via the route #1 with respect to the route #2 and the route #3. When the So receives the FAIL, both DNU of the routes #2 and #3 are issued toward the Sk at a time.

Formerly, the FAIL and the DNU respectively related to the routes #2 and #3 are sent and received individually; and accordingly, a data loss time of t4 is generated as shown in FIG. 4. On the other hand, the data loss time is shortened in the first exemplary embodiment, as shown in FIG. 12 (t5(<t4) in the drawing).

### Second Exemplary Embodiment

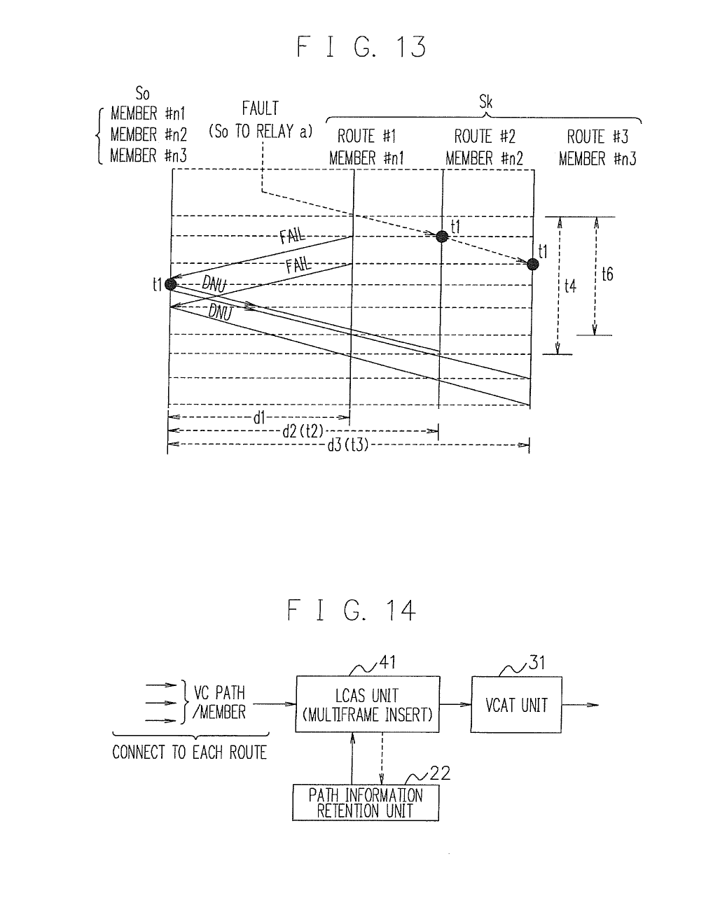

A second exemplary embodiment will be described with reference to FIGS. 3, 5, and 13. FIG. 13 shows an LCAS process sequence which leads to autonomous deletion of a VC path/member at the time when a fault occurs in a zone (Link #1) in which two routes (route #2 and route #3), where there exists a path difference in the case where a main signal process of an So is the configuration shown in FIG. 1 and a main signal process of an Sk is the configuration shown in FIG. 13, run in parallel.

In the second exemplary embodiment, since the Sk is a conventional configuration, FAIL is transmitted toward the So for the respective routes #2 and #3 as formerly.

On the other hand, when FAIL from the Sk is received by a VC path/member whose path is a short route (route #2), the So refers to a path information retention unit 10, recognizes its path group, and comprehends a relation between the self So and an adjacent node; and in the case where a fault occurs in the route #2, the Sk recognizes that the route #3 with which the Link #1 is shared is also out of order.

Consequently, the So issues DNU with respect to the routes #2 and #3 toward the Sk at a time. VC paths/members belonging to path groups associated with the Sk which received the DNU, subsequently, comply with a normal LCAS procedure.

Formerly, the FAIL and the DNU respectively related to the routes #2 and #3 are sent and received individually; and accordingly, a data loss time of t4 is generated as shown in FIG. 4. On the other hand, the data loss time is shortened in the second exemplary embodiment as shown in FIG. 13 (t6(<t4) in the drawing).

### Other Exemplary Embodiment

Such a configuration is conceivable that there exists an empty byte such as an F3 byte in a path overhead (POH) in VC; therefore, path information (including adjacent node information of an So) as shown in FIG. 8 is outputted from a path information retention unit 10 of the So to an LCAS unit 40 as shown in FIG. 5, and is inserted to an empty byte in a main signal by the LCAS unit 40; and then, the path information is extracted by an LCAS unit 41 of an Sk, and is outputted to a path information retention unit 22 as shown in FIG. 14.

According to this, the adjacent node information of the So is obtained on only the So side; on the Sk side, the adjacent node information of the So can be obtained from the path overhead of the VC path; and therefore, it becomes possible to actualize an efficient transmission of the adjacent node information of the So.

Furthermore, such a configuration is also conceivable that path information as shown in FIG. 11 based on an NMS is outputted from a path information retention unit 11 of an So to an LCAS unit 40, and is inserted to an empty byte of a main signal by the LCAS unit 40 as shown in FIG. 9; and then, the path information is extracted by an LCAS unit 41 of an Sk, and is outputted to a path information retention unit 22 as shown in FIG. 14.

There is a following advantage of the present invention as an example. VC paths/members generated by a VCAT is treated by dividing one data set to a VC path/member unit on transmission paths; and therefore, it is effective from the view point of application of a band in an SDH/SONET digital transmission network; however, when a fault occurs in the VC paths/members, the band reduces for each unit thereof.

In addition, when a control procedure such as an LCAS is implemented, there is no problem from the view point of implementation of addition or deletion of a band without instantaneous interruption by commands; however, as for implementation of autonomous deletion or recovery of a VC path/member at fault time, its necessary time has a large influence on an amount of loss data.

(amount of loss data)=(band of VC path/member in which fault occurs)×(necessary time for LCAS in each VC path/member+round-trip propagation delay)

There is a greater possibility that the fault in the transmission path occurs in a path unit, but not in a VC path/member unit. Therefore, grouping is made in the path unit as in the present invention, a path deletion process of all members included in a group when a fault occurs or a path addition process of all members included in a group when a fault is recovered is performed in a lump; and accordingly, there is expected an advantages that a necessary time for an LCAS, that is, a data loss time, which is associated with a delay due to a process for each member pursuant to a conventional LCAS control procedure or a propagation delay due to a path difference, is reduced.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A VCAT transmission system, comprising:
a source node that accommodates an input signal in a path signal of a virtual container (VC) unit and transmits by using a VC path; and
a sink node that receives the path signal of the VC unit, transmitted by the VC path and outputs a received signal,
wherein the source node or the sink node comprises a unit that retains path information of the VC path.

2. The VCAT transmission system according to claim 1, wherein the path information is grouped in a path unit for each connection destination.

3. The VCAT transmission system according to claim 1, wherein the path information includes information of a node adjacent to the source node.

4. The VCAT transmission system according to claim 1, wherein the path information includes information of a relay node on a path from the source node to the sink node.

5. The VCAT transmission system according to claim 2, wherein the retaining unit mounts the path information in an empty byte of a path overhead in a VC and transmits when the path information is transmitted from the source node to the sink node.

6. A VCAT transmission system, comprising:
a source node that accommodates an input signal in a path signal of a virtual container (VC) unit and transmits by using a VC path; and
a sink node that receives the path signal of the VC unit, transmitted by the VC path and outputs a received signal,
wherein the source node or the sink node comprises means for retaining path information of the VC path.

7. A source node applied to a VCAT transmission system, the VCAT transmission system comprising:
the source node that accommodates an input signal in a path signal of a VC unit and transmits by using a VC path; and
a sink node that receives the path signal of the VC unit, transmitted by the VC path and outputs a received signal, the source node comprising:
a unit that retains path information of the VC path.

8. The source node according to claim 7, wherein the path information is grouped in a path unit for each connection destination.

9. The source node according to claim 7, wherein the path information includes information of a node adjacent to the self source node.

10. The source node according to claim 7, wherein the path information includes information of a relay node on a path from the self source node to the sink node.

11. The source node according to claim 8, further comprising a unit that, when a fault occurrence on a path is notified from the sink node, transmits a use prohibition notification to the sink node at substantially the same time for one or more connection (VC path) belonging to a group of the fault occurrence path on a basis of the path information.

12. A source node applied to a VCAT transmission system, the VCAT transmission system comprising:
the source node that accommodates an input signal in a path signal of a VC unit and transmits by using a VC path; and
a sink node that receives the path signal of the VC unit, transmitted by the VC path and outputs a received signal, the source node comprising:
means for retaining path information of the VC path.

13. A sink node applied to a VCAT transmission system, the VCAT transmission system comprising:
a source node that accommodates an input signal in a path signal of a VC unit and transmits by using a VC path; and
the sink node that receives the path signal of the VC unit transmitted by the VC path and outputs a received signal, the sink node comprising:
a unit that retains path information of the VC path.

14. The sink node according to claim 13, wherein the path information is grouped in a path unit for each connection destination.

15. The sink node according to claim 13, wherein the path information includes information of a node adjacent to the source node.

16. The sink node according to claim 13, wherein the path information includes information of a relay node on a path from the source node to the self sink node.

17. The sink node according to claim 14, further comprising a unit that, when a fault occurrence on a path is detected, transmits a fault occurrence notification of one or more connection (VC path) belonging to a group of the fault occurrence path to the source node on a basis of the path information by using a shortest path without via the fault occurrence path belonging to the group of the fault occurrence path.

18. A sink node applied to a VCAT transmission system, the VCAT transmission system comprising:
a source node that accommodates an input signal in a path signal of a VC unit and transmits by using a VC path; and
the sink node that receives the path signal of the VC unit transmitted by the VC path and outputs a received signal, the sink node comprising:
means for retaining path information of the VC path.

19. A VCAT band control method that is applied to a VCAT transmission system, the VCAT transmission system comprising:
a source node that accommodates an input signal in a path signal of a VC unit and transmits by using a VC path; and
a sink node that receives the path signal of the VC unit transmitted by the VC path and outputs a received signal, the VCAT band control method being performed by the source node and comprising the steps of:
retaining and using information of a node adjacent to the self source node or information of a relay node on a path from the self source node to the sink node as path information by the source node.

20. The VCAT band control method according to claim 19, wherein the path information is grouped in a path unit for each connection destination.

21. The VCAT band control method according to claim 19, wherein, when a fault occurrence on a path is notified from the sink node, the source node further transmits a use prohibition notification of a connection (VC path) belonging to a group of the fault occurrence path to the sink node at substantially the same time on a basis of the path information.

22. A VCAT band control method that is applied to a VCAT transmission system, the VCAT transmission system comprising:
a source node that accommodates an input signal in a path signal of a VC unit and transmits by using a VC path; and
a sink node that receives the path signal of the VC unit transmitted by the VC path and outputs a received signal, the VCAT band control method being performed by the sink node and comprising the steps of:
retaining and using information of a node adjacent to the source node or information of a relay node on a path from the source node to the self sink node as path information by the sink node.

23. The VCAT band control method according to claim 22, wherein the path information is grouped in a path unit for each connection destination.

24. The VCAT band control method according to claim 22, wherein, when a fault occurrence on a path is detected, the sink node further transmits a fault occurrence notification of a connection (VC path) belonging to a group of the fault occurrence path to the source node on a basis of the path information by using a shortest path without via the fault occurrence path belonging to the group of the fault occurrence path.

25. The VCAT band control method according to claim 23, wherein the path information is mounted in an empty byte of a path overhead in a VC and is transmitted when the path information is transmitted from the source node to the sink node.

26. A computer-readable medium storing a program that allows a general purpose information processing apparatus in a VCAT transmission system to actualize a function commensurate with a function of a source node, the VCAT transmission system comprising:
a source node that accommodates an input signal in a path signal of a VC unit and transmits by using a VC path; and
a sink node that receives the path signal of the VC unit transmitted by the VC path and outputs a received signal, the program allowing the information processing apparatus to implement the processes of:
retaining and using information of a node adjacent to the self source node or information of a relay node on a path from the self source node to the sink node as path information that is grouped in a path unit for each connection destination, as the source node.

27. The computer-readable medium storing a program according to claim 26, wherein, when a fault occurrence on a path is notified from the sink node, the program allows the information processing apparatus to further implement the process of: transmitting a use prohibition notification of a connection (VC path) belonging to a group of the fault occurrence path to the sink node at substantially the same time on a basis of the path information, as the source node.

28. A computer-readable medium storing a program that allows a general purpose information processing apparatus in a VCAT transmission system to actualize a function commensurate with a function of a sink node, the VCAT transmission system comprising:
a source node that accommodates an input signal in a path signal of a VC unit and transmits by using a VC path; and
a sink node that receives the path signal of the VC unit transmitted by the VC path and outputs a received signal, the program allowing the information processing apparatus to implement the processes of:
retaining and using information of a node adjacent to the source node or information of a relay node on a path from the source node to the self sink node as path information that is grouped in a path unit for each connection destination, as the sink node.

29. The computer-readable medium storing a program according to claim 28, wherein, when a fault occurrence on a path is detected, the program allows the information processing apparatus to further implement the process of: transmitting a fault occurrence notification of a connection (VC path) belonging to a group of the fault occurrence path to the source node on a basis of the path information by using a shortest path without via the fault occurrence path belonging to the group of the fault occurrence path, as the sink node.
